(19) United States
(12) Patent Application Publication
(10) Pub. No.: US 2018/0216826 A1
(43) Pub. Date: Aug. 2, 2018

(54) DEVICE TO CORRECT FLOW NON-UNIFORMITY WITHIN A COMBUSTION SYSTEM

(71) Applicant: DOOSAN HEAVY INDUSTRIES CONSTRUCTION CO., LTD., Gyeongsangnam-do (KR)

(72) Inventors: Kevin SPENCE, Jupiter, FL (US); Esam ABU-IRSHAID, Lake Worth, FL (US)

(21) Appl. No.: 15/419,764

(22) Filed: Jan. 30, 2017

(51) Int. Cl. F23R 3/10

(52) U.S. Cl. CPC F23R 3/10; F05D 2240/35

(57) ABSTRACT

A flow controller in a combustor of a gas turbine includes a body and a flow regulating portion configured to be placed in an air path providing air flow to a combustion chamber, the flow regulating portion including a plurality of holes configured to regulate the amount of air provided to one or more fuel nozzles in the combustor.

### CROSS-REFERENCE TO RELATED APPLICATIONS

This application is related to co-pending U.S. patent application Ser. No. 15/410,109, entitled “FLOW CONDITIONER TO REDUCE COMBUSTION DYNAMICS IN A COMBUSTION SYSTEM,” filed Jan. 19, 2017, and co-pending U.S. patent application Ser. No. 15/414,063, entitled “RESONATOR FOR DAMPING ACOUSTIC FREQUENCIES IN THE COMBUSTION SYSTEM BY OPTIMIZING IMPINGEMENT HOLES AND SHELL VOLUME,” filed Jan. 24, 2017, which are incorporated herein by reference.

### BACKGROUND

Combustors, such as those used in industrial gas turbines, for example, mix compressed air with fuel and expel high temperature, high pressure gas downstream. The energy stored in the gas is then converted to work as the high temperature, high pressure gas expands in a turbine, for example, thereby turning a shaft to drive attached devices, such as an electric generator to generate electricity. For any given gas turbine, there may be several combustors, with each combustor housing multiple fuel nozzles.

The layout of a gas turbine mid-frame is typically obstructed by various components such as an inlet diffuser, transition mount, and various piping and components that may be distributed throughout the mid-frame. While the inlet diffuser provides a general diffusion of the air entering into the mid-frame, these structural obstructions lead to flow non-uniformity as the air enters the combustors. For example, the obstructions can cause the air to flow more readily to the upper portion of the headend while restricting airflow to the lower portion of the headend, providing more air to the combustors at the top of the turbine while less air is supplied to the combustors at the low portion. Further, while equal amounts of fuel are being supplied to each of the fuel nozzles, any unequal amounts of air supplied to each individual fuel nozzle shroud may create areas of richer air/fuel mixture potentially leading to burning within the nozzle shroud, for example. This may lead to overheated components and failure of the fuel shroud or injector, among other operational disruptions and damage to the system.

### BRIEF SUMMARY

In one embodiment of the invention, a combustor of a gas turbine comprises one or more fuel nozzles arranged in a headend of the combustor, a combustion chamber in which mixture of air and fuel is combusted, an air path providing air flow to the combustion chamber, and a flow controller placed in the air path to regulate the amount of air provided to the one or more fuel nozzles.

In another embodiment of the invention, a flow controller in a combustor of a gas turbine comprises a body and a flow regulating portion configured to be placed in an air path providing air flow to a combustion chamber, the flow regulating portion including a plurality of holes configured to regulate the amount of air provided to one or more fuel nozzles in the combustor.

### BRIEF DESCRIPTION OF DRAWINGS

FIG. 1 shows a combustion system in an exemplary gas turbine, according to an example embodiment.

FIG. 2 shows a sectional view of a combustor, according to an example embodiment.

FIG. 3 shows a sectional view of a headend area of a combustor, according to an example embodiment.

FIG. 4 shows a perspective view of a flow controller, according to an example embodiment.

FIGS. 5A and 5B show exemplary screen holes of a flow controller, according to example embodiments.

FIGS. 6A-6D show exemplary shapes of screen holes, according to example embodiments.

FIGS. 7A and 7B show exemplary variations of porosity, according to example embodiments.

### DETAILED DESCRIPTION

Various embodiments of a flow controller that provides equalized distribution of air entering into each fuel nozzle of a combustor are described. It is to be understood, however, that the following explanation is merely exemplary in describing the devices and methods of the present disclosure. Accordingly, any number of reasonable and foreseeable modifications, changes, and/or substitutions are contemplated without departing from the spirit and scope of the present disclosure.

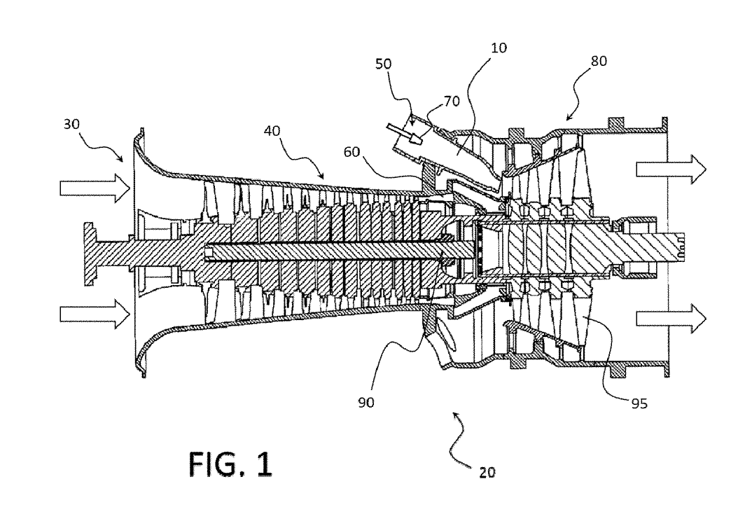

FIG. 1 shows combustor 10 according to an exemplary embodiment. For purposes of explanation only, the combustor 10 is shown in FIG. 1 as applied to an industrial gas turbine 20. However, combustors of other applications may be applied without departing from the scope of the present invention. For purposes of explanation and consistency, like reference numbers are directed to like components in the figures.

As shown in FIG. 1, air to be supplied to the combustor 10 is received through air intake section 30 of the gas turbine 20 and is compressed in compression section 40. The compressed air is then supplied to headend 50 through air path 60. The air is mixed with fuel and combusted at the tip of fuel nozzles 70 and the resulting high temperature, high pressure gas is supplied downstream. In the exemplary embodiment shown in FIG. 1, the resulting gas is supplied to turbine section 80 where the energy of the gas is converted to work by turning shaft 90 connected to turbine blades 95.

While the exemplary embodiment shown in FIG. 1 shows one combustor 10 including one fuel nozzle 70 for simplicity, there may be multiple combustors 10 positioned at different locations within the headend 50, with multiple fuel nozzles 70 in each combustor 10. As the compressed air enters the headend 50, various obstructions such as inlet diffuser, transition mount, and various piping and components (not shown) may create non-uniform distribution of air to each of the combustors 10. Further non-uniform distribution of air may be created within the combustor 10, thereby causing uneven distribution of air supplied to each fuel nozzle 70 within the combustor 10. In other words, the amount of air supplied may be different between each combustor 10 as well as between each fuel nozzle 70 within combustor 10.

According to exemplary embodiments described below, a flow controller is provided to supply uniform amounts of air mass flow to each combustor 10. Further, exemplary embodiments described below also provide uniform amounts of air mass flow to each fuel nozzle 70 in a combustor 10.

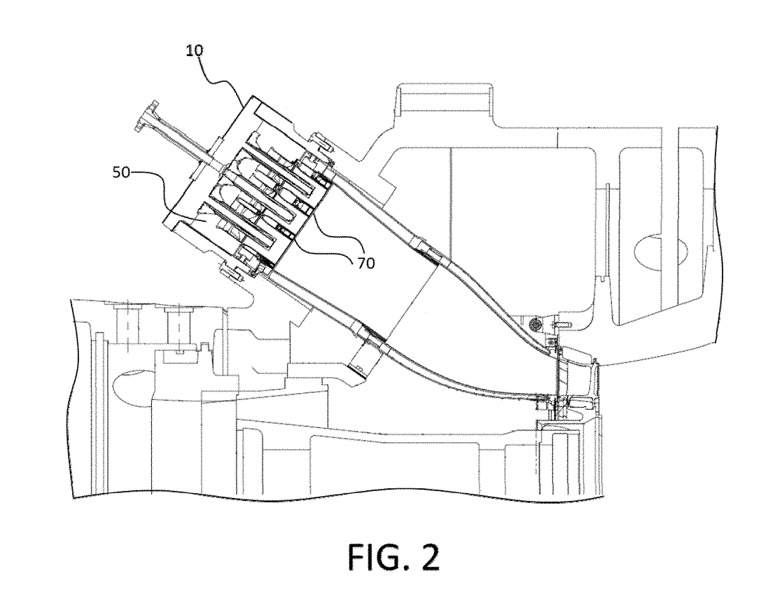

FIG. 2 is a sectional view of an exemplary combustor 10. Combustor 10 includes one or more fuel nozzles 70 in the headend 50. It is to be understood that there may be one or more combustors 10 in any given gas turbine.

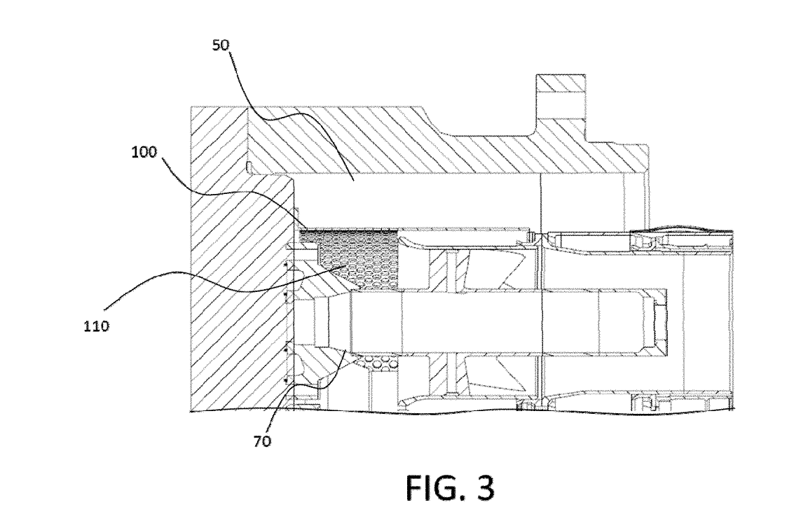

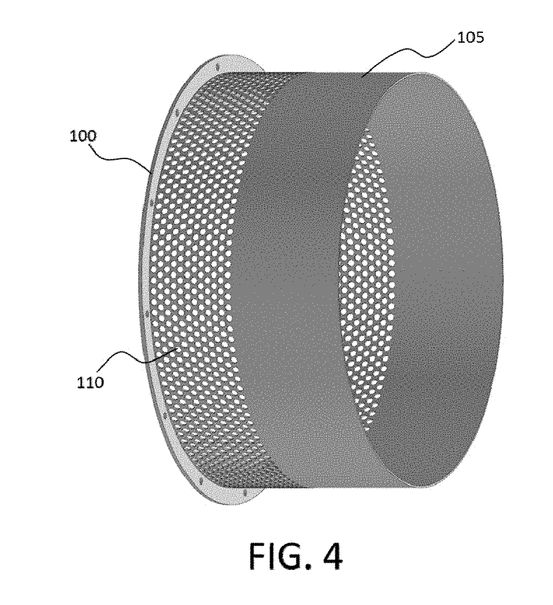

FIG. 3 is a sectional view of an exemplary embodiment of headend 50. In this exemplary embodiment, the flow controller 100 is shown surrounding a fuel nozzle 70 in a combustor 10. FIG. 4 is a perspective view of an exemplary flow controller 100. The flow controller 100 includes a body 105 having a plurality of holes 110, which causes a pressure drop and the make the air distribution more even. In addition to the size and shape of the holes 110, the porosity (i.e., number of holes in a given area) of the flow controller 100 affects the amount of air distribution supplied to the fuel nozzle 70. Accordingly, holes 110 can be made in different sizes and shapes. Further, the number of holes (i.e., porosity) may be uniform throughout the flow controller 100 or may be varied in two or more sections to target specific air mass flow requirements for each fuel nozzle 70.

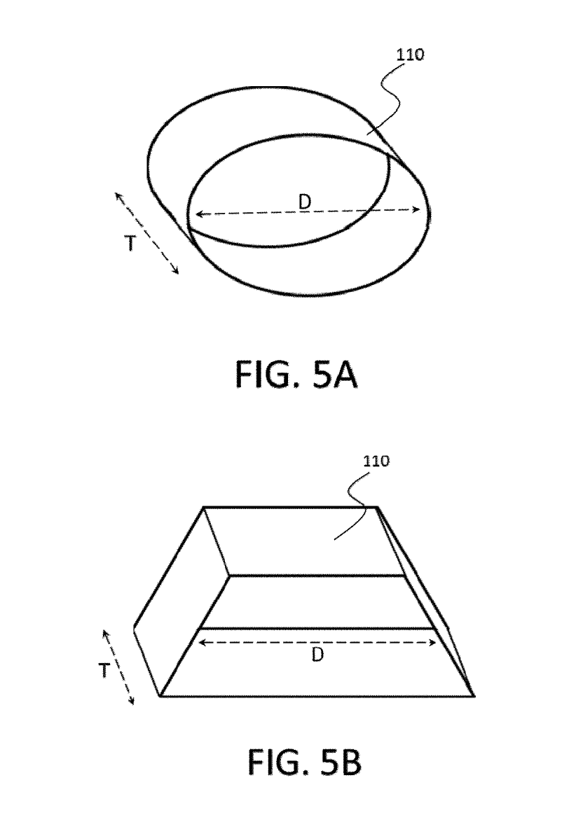

FIGS. 5A and 5B show exemplary shapes and sizes of hole 110. The size of hole 110 may be varied by adjusting diameter (D) and/or thickness (T). Furthermore, the shape of the hole 110 produces different air flow dynamics depending on the smoothness (or jaggedness) of the hole. For instance, a cylindrical shape in FIG. 5A produces a different air flow than a trapezoidal shape FIG. 5B. Further, changes in the angle of the trapezoid in FIG. 5B causes further shifts in air flow. While only two exemplary shapes are shown in FIGS. 5A and 5B, other shapes may be used without departing from the scope of the present invention.

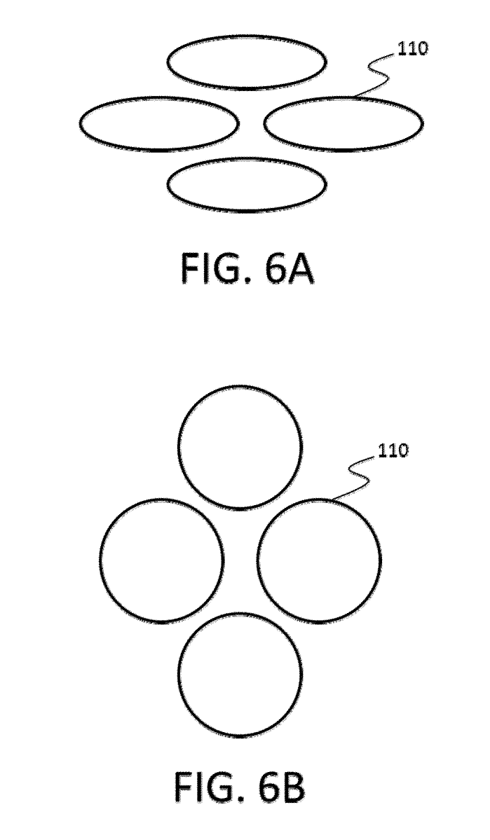

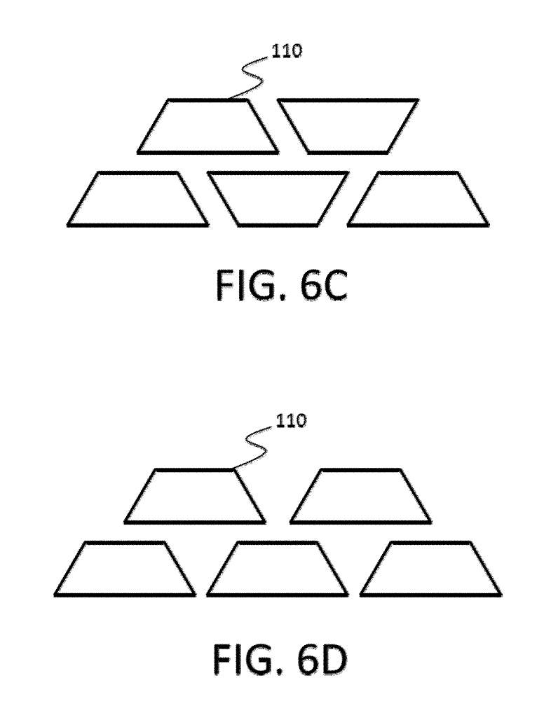

FIG. 6A-6D show exemplary embodiments of the arrangement of the various hole shapes on flow controller 100. Other shapes and arrangements may be used without departing from the scope of the present invention. In the exemplary embodiment shown in FIGS. 6A-6D, holes 110 are shown to be uniform in size and shape. However, the size and shape of holes 110 may be varied on flow controller 100 to fine tune the amount of air flow around each fuel nozzle 70 without departing from the scope of the present invention.

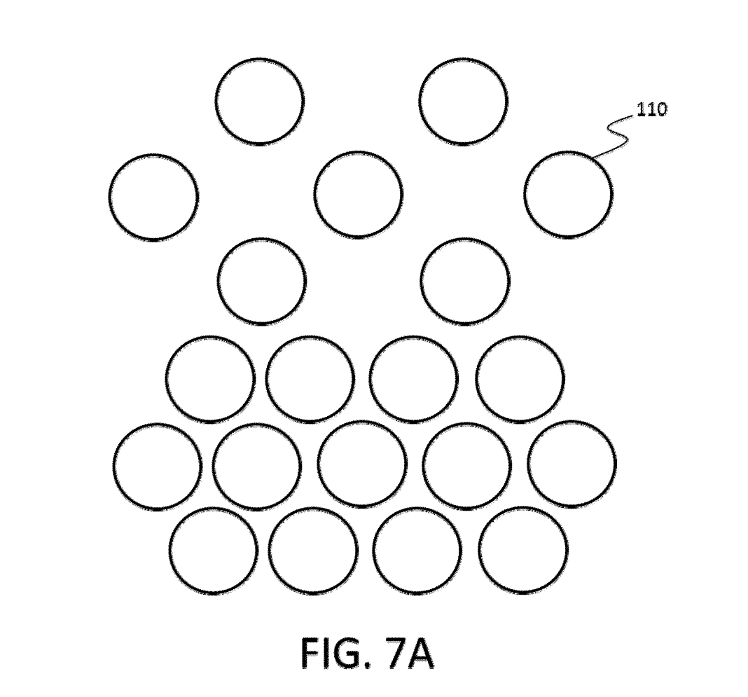

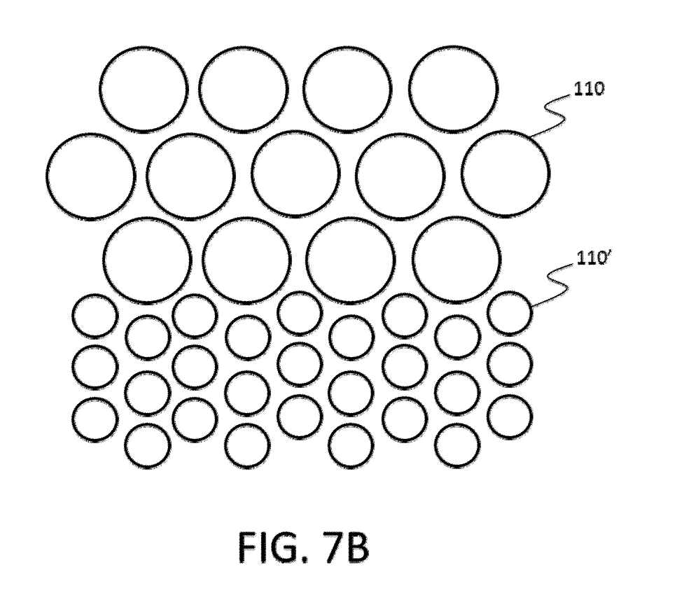

FIGS. 7A and 7B show exemplary embodiments of porosity of flow controller 100. While porosity may be uniform though out the surface of flow controller 100, a combustion system may utilize different sized swirlers (i.e., fuel nozzles 70, which create different amount of swirl based on the velocity of the combusted gas) where each fuel nozzle 70 may require different amounts of air. Accordingly, porosity may be varied on two or more sections of the flow controller 100 as shown in FIG. 7A. Further, different sized holes (110 and 110′) may be combined with variations of porosity as shown in FIG. 7B to adjust the amount of air flow to fuel nozzle 70. Additionally, the shapes of holes 110 and 110′ may also be varied to fine tune the air flow around the fuel nozzle 70 without departing from the scope of the present invention. Accordingly, the level of porosity within the flow controller 100 may be adjusted in two or more sectors to match the air flow requirements of each nozzle.

While the above exemplary embodiments are described in relation to one fuel nozzle 70 in a combustor 10, in another exemplary embodiment, flow controller 100 may be placed around each fuel nozzle in a multi-nozzle combustor. Further, flow controller 100 may have different size, shape, and porosity to match the air flow need of each fuel nozzle 70.

In another exemplary embodiment, flow controller 100 as described above may be placed around the entire fuel nozzle assembly of a combustor 10 rather than around each fuel nozzle 70. Here, different sections of the flow controller 100 as described above may be formed with holes having differing size, shape, and/or porosity to adjust the air flow of the entire fuel nozzle assembly. In the alternative, flow controller 100 as described above may be placed at the entrance of the air path to the headend 50 to provide uniform air distribution of the compressed air to all of the nozzles 70 in the combustor 10. The foregoing exemplary embodiments may be combined to increase the efficiency as well as longevity of the combustion system without having to redesign or rearrange the internal structure of the combustion system.

Some of the advantages of the exemplary embodiments include: prevention of flashback and improved emissions by ensuring ideal air/fuel mixture through each fuel injector nozzle, reduced or eliminated flashback damage and ensure components meets service life target, and improved emissions will provide competitive market advantage.

It will also be appreciated that this disclosure is not limited to industrial gas turbines. For example, combustion systems in aero gas turbines and gas turbines in general can also realize advantages of the present disclosure. Further, the shapes, sizes, and thicknesses of the screen holes are not limited to those disclosed herein. For example, screen holes in the shape of a square, rectangle, triangle, and other polygonal structures, such as pentagon, hexagon, and octagon to name a few examples can also realize the advantages of the present disclosure. Additionally, the holes may be formed by various processes such as piercing, punching, or boring to form a perforated structure, or by die casting, for example.

The breadth and scope of the present disclosure should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A combustor of a gas turbine, comprising:
one or more fuel nozzles arranged in a headend of the combustor;
a combustion chamber in which mixture of air and fuel is combusted;
an air path providing air flow to the combustion chamber; and
a flow controller placed in the air path to regulate the amount of air provided to the one or more fuel nozzles.

2. The combustor of claim 1, wherein the flow controller is arranged around each of the one or more fuel nozzles.

3. The combustor of claim 1, wherein the flow controller has a perforated structure.

4. The combustor of claim 1, wherein the flow controller comprises:
a body; and
a flow regulating portion configured to be placed in the air path, the flow regulating portion including a plurality of holes configured to regulate the amount of air provided to the one or more fuel nozzles.

5. The combustor of claim 4, wherein the flow regulating portion has a perforated structure.

6. The combustor of claim 4, wherein the plurality of holes are cylindrical.

7. The combustor of claim 4, wherein the plurality of holes are polygonal.

8. The combustor of claim 4, wherein the plurality of holes have different shapes.

9. The combustor of claim 4, wherein the plurality of holes have different sizes.

10. The combustor of claim 4, wherein the flow regulating portion has varying porosity.

11. A flow controller in a combustor of a gas turbine, comprising:
a body; and
a flow regulating portion configured to be placed in an air path providing air flow to a combustion chamber, the flow regulating portion including a plurality of holes configured to regulate the amount of air provided to one or more fuel nozzles in the combustor.

12. The flow controller of claim 11, wherein the flow regulating portion has a perforated structure.

13. The flow controller of claim 11, wherein the flow regulating portion is configured to surround each one of the one or more fuel nozzles.

14. The flow controller of claim 11, wherein the plurality of holes are cylindrical.

15. The flow controller of claim 11, wherein the plurality of holes are polygonal.

16. The flow controller of claim 11, wherein the plurality of holes have different shapes.

17. The flow controller of claim 11, wherein the plurality of holes have different sizes.

18. The flow controller of claim 11, wherein the flow regulating portion has varying porosity.
